(19) United States
(12) Patent Application Publication
(10) Pub. No.: US 2006/0211409 A1
(43) Pub. Date: Sep. 21, 2006

(54) MiPod - secure digital cell phone

(76) Inventor: Marlon St. Peter Davis, Bronx, NY (US)

Correspondence Address: Marlon Davis, 732 East 231 Street, Bronx, NY, 10466, US

(21) Appl. No.: 11/047,166

(22) Filed: Mar. 16, 2005

(51) Int. Cl. H04M 1/00

(52) U.S. Cl. 455/412.1; 455/418

(57) ABSTRACT

The new product idea/concept “MiPod—secure digital cell phone” has the ability of a cell phone to play large MP3/MP4/MPEG play list files, transfer and store data onto your cell phone. The main feature for this phone idea/concept is the secure digital expansion slot built into the cell phone for additional memory to store and transfer data (ex: .doc, .ppt, mp3, mp4, mpeg, & etc.) onto a secure digital card. You can also in turn swap optionally from any digital device like a digital camera for example that uses a secure digital card which you can then use your phone to view images taken from the digital camera. Also there is a USB port, which you can sync to any PC using a sync CD or a website which will be available for a sync download for downloading, uploading, file transfer and storage purposes.

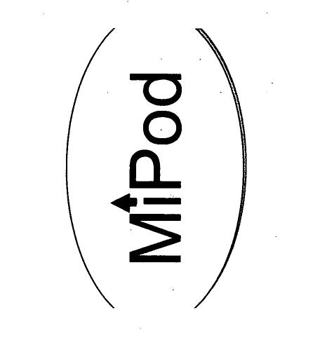

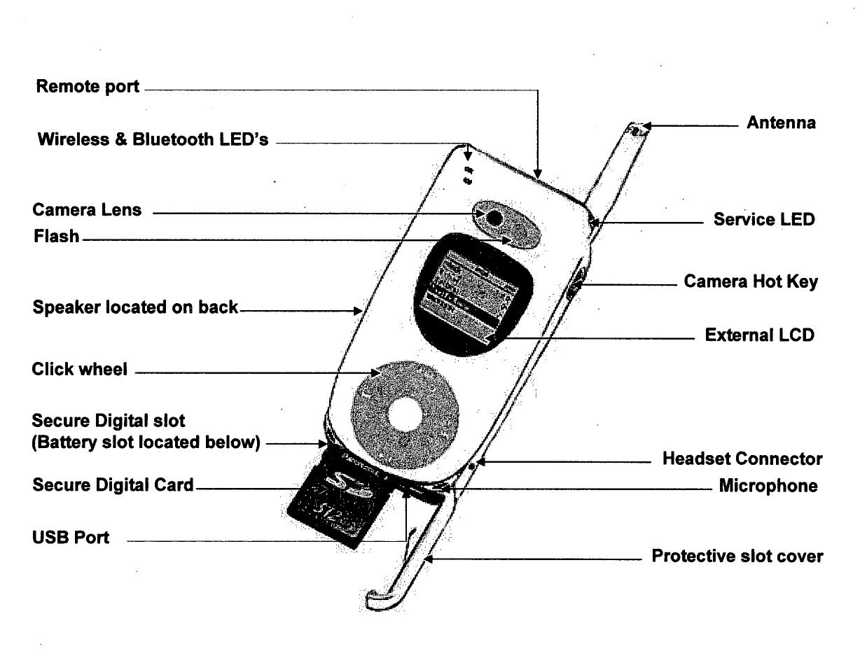

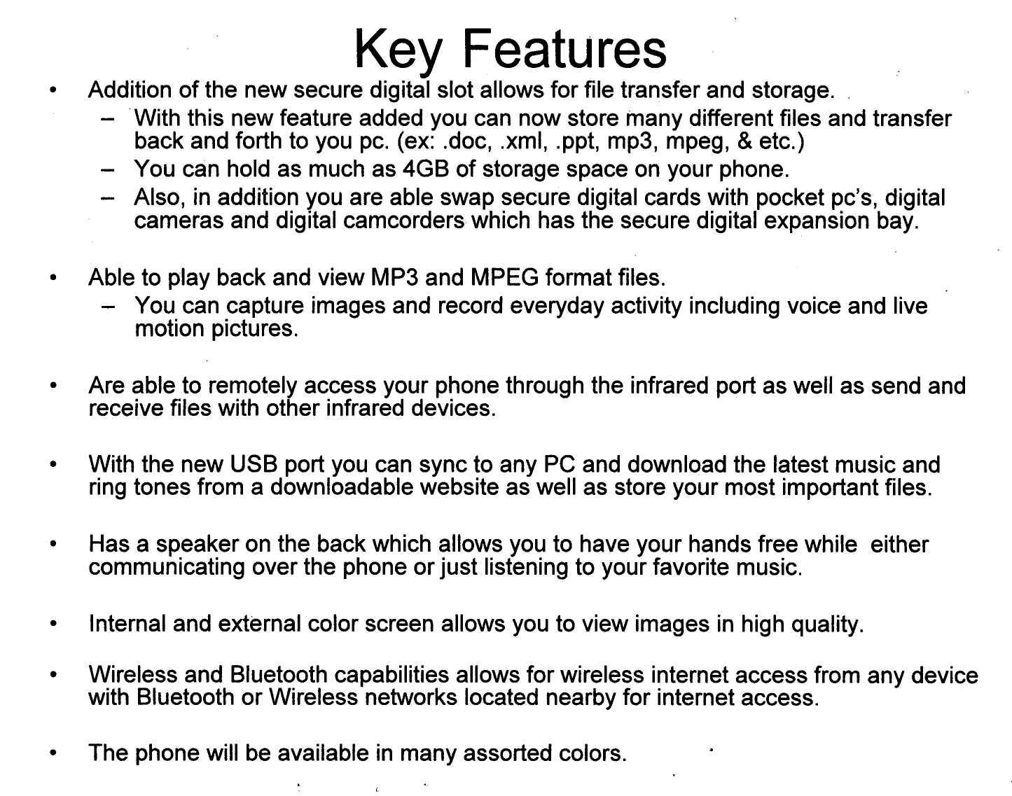

The new product idea/concept is to have the ability of your cell phone to have and play large MP3/MP4/MPEG play list files, transfer and store large data onto your cell phone. For this to happen, you will need the new MiPod secure digital cell phone. The new feature mainly for this new phone idea/concept is the new secure digital expansion slot added into the cell phone for file transfer and storage capabilities. This allows for a secure digital card to be accessed by your cell phone which you can in turn swap optionally from any digital device like a digital camera for example that uses a secure digital card which you can then use your phone to view images taken from the digital camera. With the new expansion slot added along with the USB port, you're now able to sync to any PC using a sync CD or the website which will be available for a sync download for downloading, uploading, file transfer and storage purposes.

This new idea fulfills the needs of any individual who likes the convenience of a cell phone, storage device and an MP3/MP4/MPEG player all combined into one. It solves the problem of storing large data into large storage devices as well as also playing and viewing media files.

I Marlon Davis claim:

1. MiPod secure digital cell phone fulfills the needs of any individual who likes the convenience of a cell phone, storage device and an MP3/MP4/MPEG player all combined into one. It solves the problem of storing large data into large storage devices as well as also playing and viewing media files.

2. MiPod secure digital cell phone, as in claim 1 has the ability to play and store large MP3/MP4/MPEG play list files.
Able to play back and view MP3, MP4 and MPEG format files.
You can capture images and record everyday activity including voice and live motion pictures.

3. MiPod secure digital cell phone, as in claim 1 has the ability to transfer and store large data onto your cell phone.

4. MiPod secure digital cell phone has a secure digital expansion slot added into the cell phone for file transfer and storage capabilities. This allows for a secure digital card to be accessed by your cell phone which you can in turn swap optionally from any digital device like a digital camera for example that uses a secure digital card which you can then use your phone to view images taken from the digital camera. With the expansion slot added along with the USB port/Fire wire port, you're now able to sync to any PC using a sync CD or the website which will be available for a sync download for downloading, uploading, file transfer and storage purposes.
Addition of the secure digital slot allows for file transfer and storage.
With this feature added you can store many different files and transfer back and forth to you pc. (Ex: .doc, .xml, .ppt, mp3, mp4, mpeg, & etc.)
You can hold as much as 4 GB or possibly more of storage space on your phone.
Also, in addition you are able swap secure digital cards with pocket pc's, digital cameras and digital camcorders which have the secure digital expansion bay.

5. MiPod secure digital cell phone have the ability to remotely access your phone through the infrared port as well as send and receive files with other infrared devices.

6. MiPod secure digital cell phone, as in claim 4 contains a USB port/Fire wire port you can sync to any PC and download the latest music and ring tones from a downloadable website as well as store you're most important files.

7. Has a speaker on the back which allows you to have your hands free while either communicating over the phone or just listening to your favorite music.

8. Internal and external color screen allows you to view images in high quality.

9. Wireless and Bluetooth capabilities allows for wireless internet access from any device with Bluetooth or Wireless networks located nearby for internet access.

10. The phone can be available in many assorted colors.
